(19) United States
(12) Patent Application Publication
(10) Pub. No.: US 2007/0073487 A1
(43) Pub. Date: Mar. 29, 2007

(54) System and method for predicting solar ultraviolet exposure and ultraviolet radiation hazard

(75) Inventors: Louis D. Albright, Ithaca, NY (US); Michael Hall, Ithaca, NY (US); Jennifer Mathieu, Cambridge, MA (US)

Correspondence Address: BURNS & LEVINSON, LLP;(FORMERLY PERKINS SMITH & COHEN LLP), 125 SUMMER STREET, BOSTON, MA, 02110, US

(73) Assignee: Cornell Research Foundation, Inc., Ithaca, NY (US)

(21) Appl. No.: 11/235,553

(22) Filed: Sep. 26, 2005

(51) Int. Cl. G06F 19/00

(52) U.S. Cl. 702/3

(57) ABSTRACT

A system, method, and apparatus for determining the remaining time a user has before maximum natural UV radiation exposure is reached, and the clock time at which natural UV radiation exposure should end, based on measured irradiation and other parameters.

### BACKGROUND OF THE INVENTION

This invention relates generally to natural ultraviolet (UV) radiation detection, and more specifically to a system and method for predicting personal UV exposure in order to avoid the harmful effects of UV radiation.

It is well-known that to protect the skin from various ailments, including skin cancer, protection from and avoidance of UV radiation (290-400 nm) exposure is necessary. Specifying a certain amount of UV radiation exposure for an area based on, for example, the UV Index as published by the US. Environmental Protection Agency using weighting of the McKinlay-Diffey Erythema action spectrum, can be too general to be useful. There are several devices currently available that provide personal UV radiation monitoring. The devices generally accumulate solar UV radiation and trigger an alarm when an exposure goal for the user has been exceeded. Some of these devices provide information about the amount of time the user can remain in the sun before the exposure goal is reached. Devices that require historical weather data or daily forecasts to predict UV exposure can be either inaccurate or not portable. UV exposure predictions based on average historical conditions may poorly represent any given day of weather.

What would be useful is a personal device that provides the user a predicted time at which the user's solar exposure is exceeded, where the prediction is based on an algorithm that can be applied to predict UV radiation, and optionally its separate wavelength bands, for example, UVA (315-400 nm), UVB (280-315 nm), and UVC (1-280 nm). Actual prediction of future UV exposure as a function of time could allow parents, health professionals, and others to predict, ahead of time, the time permitted before the UV exposure is exceeded. Prediction of the safe time remaining could be more useful than simply accumulating solar UV exposure and triggering a signal or alarm when the exposure goal has been exceeded.

Therefore, there is a need to provide a system and method for predicting the safe time remaining in the sun according to an algorithm that is suitable for computer implementation.

Another need is to provide a system and method to implement the algorithm in such as way as to predict UV exposure for persons outdoors.

A further need is to accumulate, continuously, solar UV irradiation since sunrise and predict the future course of exposure for the rest of the day, and use that prediction to determine the time a person can remain safely outdoors before exceeding some predetermined UV exposure limit. Solar irradiation is defined as the amount of solar radiation, direct and diffused, received at any location.

### SUMMARY OF THE INVENTION

The needs set forth above as well as further and other needs and advantages are addressed by the present invention. The solutions and advantages of the present invention are achieved by the illustrative embodiment described herein below.

The system and method of the present invention implement an algorithm that predicts UV exposure for persons outdoors and concerned with UV hazards related to skin cancer and other skin disorders caused by UV exposure. The algorithm is suitable for computer implementation. The UV exposure of typical concern occurs within the wavelengths of 290-400 nanometers, but this range is not required by the algorithm. The algorithm is based on using real time data measured with a UV sensor and is, unlike the UV Index, sensitive to, for example, current solar intensity, the time of day, the current state of the ozone layer, radiation reflected from surrounding surfaces, cloud cover, elevation of the local site above sea level, atmospheric transmittance, local haze, and air pollution (to include local ozone levels), and all other factors that affect local UV levels. The UV sensor is also sensitive to factors that are taken into account when computing the UV Index, including latitude, longitude, and day of year.

The algorithm accumulates, continuously, solar UV irradiation since sunrise and predicts the future course of exposure for the rest of the day. The prediction of future natural UV irradiation can then be used to determine the time a person can remain safely outdoors before exceeding some predetermined UV exposure limit. This predetermined exposure can be determined individually, and changed based on personal desires. The algorithm can be programmed on a small, portable device that includes one or more photocells calibrated for UV irradiation. The algorithm can be used to predict, separately, predetermined wavelength bands, for example, UVA, UVB, and UVC, provided that suitable sensors are used and filtered to accept only these wavelength bands. With a suitably filtered sensor system, predictions can be for narrower wavelength bands to permit more precise weighting of the UV exposure index. Calculations are initially made based on solar time, and the final results are then translated to clock time.

Note that system and method of the present invention can be incorporated in a standalone device or a device that can be worn by a user.

For a better understanding of the present invention, together with other and further objects thereof, reference is made to the accompanying drawings and detailed description. The scope of the present invention is pointed out in the appended claims.

### DESCRIPTION OF THE SEVERAL VIEWS OF THE DRAWING

FIG. 1 is a schematic block diagram of the system of the present invention to predict remaining solar exposure time;

FIG. 2 is a graphic representation of a plot of integrated versus instantaneous solar irradiation measurements during a day;

FIG. 3 is a flowchart of the method of the present invention for predicting remaining solar exposure time of the present invention;

FIG. 4 is a flowchart of an alternate method of the present invention for predicting remaining solar exposure time; and

FIGS. 5A and 5B are schematic diagrams illustrating a standalone and a user-worn device incorporating the system and method of the present invention.

### DETAILED DESCRIPTION OF THE INVENTION

The present invention is now described more fully hereinafter with reference to the accompanying drawings, in which the illustrative embodiment of the present invention is shown. The following configuration description is presented for illustrative purposes only. Any computer configuration satisfying the speed and interface requirements herein described may be suitable for implementing the system of the present invention.

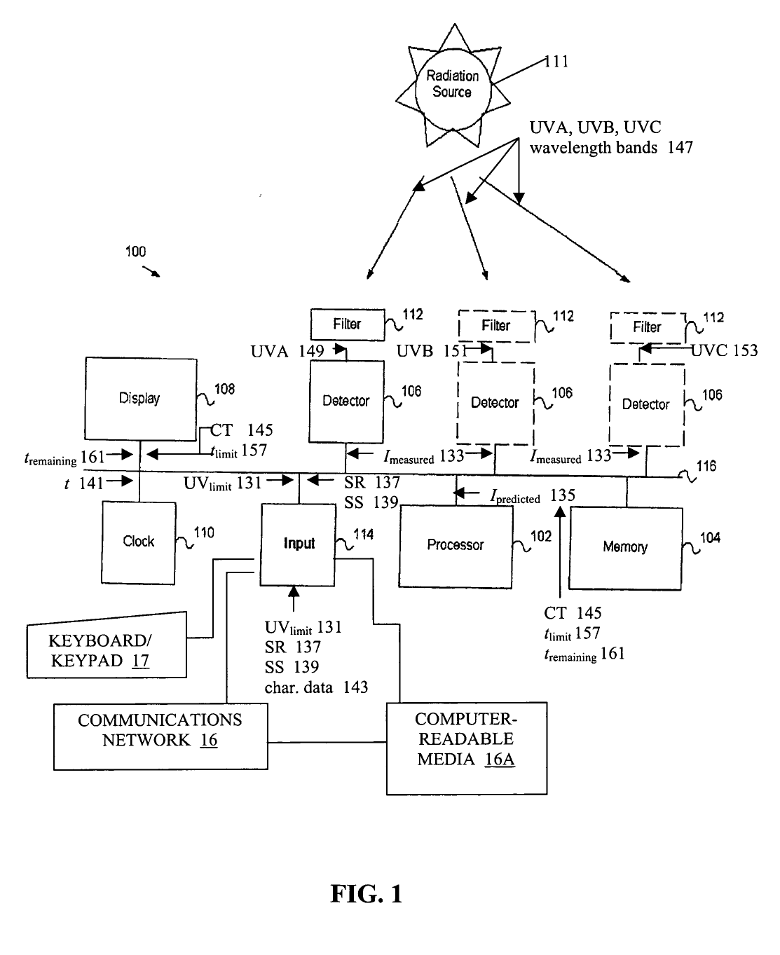

Referring now to FIG. 1, system 100 of the present invention can include, but is not limited to, at least one filter 112, at least one detector 106, electronic interface 116, clock 110, input means 114, display 108, processor 102, and memory 104. Radiation source 111, for example, the sun, provides UV radiation in the wavelength range of approximately 290-400 nm. The natural UV radiation can be divided into predetermined wavelength bands 147, for example, UVA 149, UVB 151, and UVC 153. System 100 can, optionally, filter incoming radiation source 111 through at least one filter 112, for example Andover Corporation standard filters for 200-399 nm, in order to isolate predetermined wavelength bands, for example, UVA 149 and/or UVB 151, and/or UVC 153, although typically most UVC 153 is absorbed by the ozone in the stratosphere. At least one detector 106, for example the G3614-01 UV GaAsP Photodiode manufactured by Hamamatsu®, can receive natural UV radiation source 111 (optionally filtered to isolate, for example, UVA 149 and/or UVB 151, and/or UVC 153) and can compute irradiation I_{measured} 133 and provide it to processor 102, which can be, but is not limited to, any type of general purpose or specialized computer.

Continuing to refer to FIG. 1, input means 114, which can be any type of conventional means to provide data to processor 102, for example, keyboard/keypad 17, communications network 16, or computer-readable media 16A, can receive, but is not limited to receiving, UV exposure limit UVₗᵢₘᵢₜ131, sunrise SR 137, sunset SS 139, and characteristic data 143. In one embodiment, for example, an entity such as a user of a device that implements the system of the present invention, can enter UVₗᵢₘᵢₜ131, SR 137, and SS 139 by means of keyboard/keypad 17. In anther embodiment, SR 137 and SS 139 can be calculated by processor 102 with minimal or no intervention from the user of the device. In yet another embodiment, SR 137, SS 139, and UVₗᵢₘᵢₜ131 can be computed in processor 102 based upon characteristic data 143 received from communications network 16, and/or computer-readable media 16A, and/or memory 104, and/or from a user entering data through use of keyboard/keypad 17. In any case, processor 102 receives, from various sources, I_{measured} 133, SR 137, SS 139, and t 141 (for example, from clock 110).

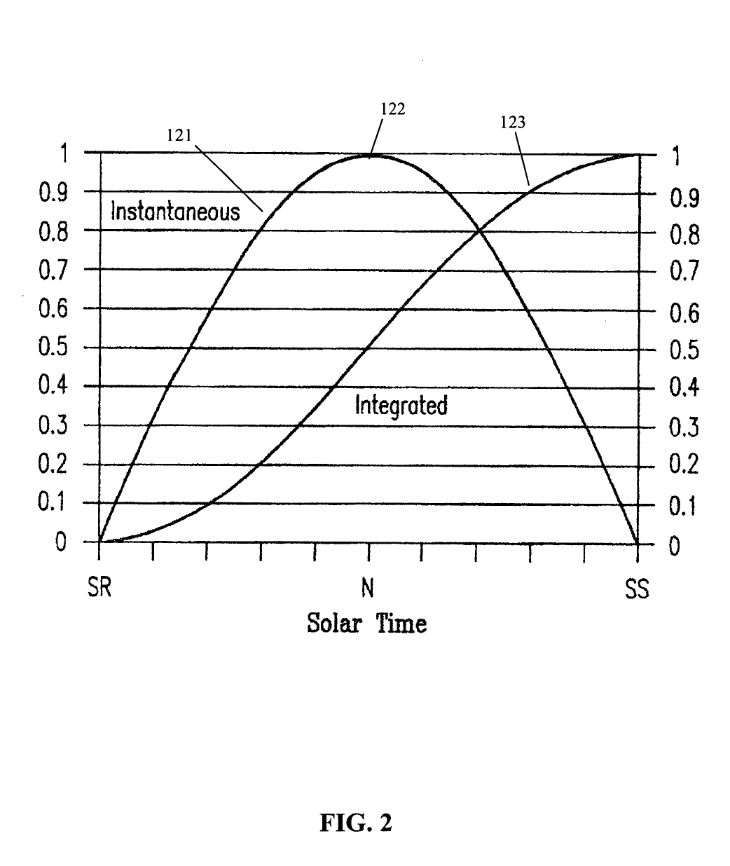

Referring now to FIGS. 1 and 2, processor 102 (FIG. 1) can compute a smoothed instantaneous irradiation Iᵢₙₛₜₐₙₜₐₙₑₒᵤₛ 121 (FIG. 2) as a function of SR, SS, t 141 (FIG. 1), and Iₘₐₓ 122 (FIG. 2), which is the maximum daily value, typically near solar noon, of the Iᵢₙₛₜₐₙₜₐₙₑₒᵤₛ 121. Iᵢₙₛₜₐₙₜₐₙₑₒᵤₛ 121 can be integrated in closed form to yield I_{integral} 123 (FIG. 2). UVₗᵢₘᵢₜ131 (FIG. 1), chosen based on desired exposure limits for the skin, can be added to I_{integral} 123, and t 141 required to add that much additional irradiation to the integral can be calculated.

Continuing to refer to FIGS. 1 and 2, the equations to perform these calculations follow:
Iᵢₙₛₜₐₙₜₐₙₑₒᵤₛ=Iₘₐₓ*sin [π(t−SR)/(SS−SR)] (1)
where SR 137 (FIG. 1) is the hour (decimal) of sunrise, and SS 139 (FIG. 1) is the hour (decimal) of sunset. A correction for atmospheric transmittance such as, for example, _=a₀+a₁ exp(−k/sin(_)), can also be used, where a₀, a₁, and k are functions of altitude and visibility and are found in conventional empirical tables providing such information, and _ is the solar altitude calculated from conventional solar equations. Iᵢₙₛₜₐₙₜₐₙₑₒᵤₛ 121 is based on the assumption of idealized daily natural UV radiation source 111 (FIG. 1), and follows a sine curve in a perfect situation, starting at sunrise and ending at sunset (ignoring contributions of twilight to the daily total). Daily values of SR 137 and SS 139 can be calculated based on local latitude and longitude, and the current date, using standard solar angle calculations. Units for Iᵢₙₛₜₐₙₜₐₙₑₒᵤₛ 121 are irrelevant for the equation but can be based on specific wavelengths and integrated over the UV spectrum, or can be weighted to be commensurate with the UV Index. An atmospheric transmittance value could be added for more precision during the early and late hours of sunlight.
I_{integral}=A*Iₘₐₓ*[(SS−SR)/π]*{1−cos [π(t−SR)/(SS−SR)]} (2)
where A may be needed to convert units, depending on the measured units of Iₘₐₓ 122 and the desired units of I_{integral} 123. Readings taken on a frequent interval (for example, every minute) can be used to continuously update measured I_{integral} 123, I_{measured} 133, for the day. Iₘₐₓ 122 can continuously be recomputed as measurements are taken:
Iₘₐₓ=I_{measured}/{A*[(SS−SR)/π]*[1−cos(π(t−SR)/(SS−SR))]} (3)
and Iₜₒₜₐₗ, the value of I_{integral} 123 at t=SS, can be continuously recomputed:
Iₜₒₜₐₗ=A*Iₘₐₓ*[(SS−SR)/π] (4)
or
Iₘₐₓ=Iₜₒₜₐₗ/{A*[(SS−SR)/π]} (5)

Eliminating Imax 122, a value for the total predicted irradiation exposure (Ipredicted) 135, as a function of Imeasured 133, t 141, SR 137, and SS 139 can be computed as follows:
I_{predicted}=I_{measured}/[1−cos(π(t−SR)/(SS−SR))] (6)
Adding the pre-selected exposure limit, UVₗᵢₘᵢₜ131, to I_{measured} 133 allows the computation of the time at which exposure should be discontinued:
tₗᵢₘᵢₜ=[(SS−SR)/]*{acos(1+[(I_{measured}+UVₗᵢₘᵢₜ)/I_{predicted})]}+SR (7)

Further, processor 102 (FIG. 1) can compute clock time (CT) 145 (FIG. 1) at which UV radiation exposure should end, and t_{remaining} 161 (FIG. 1), the remaining time the user has before maximum radiation exposure is reached. Processor 102 can provide limiting time tₗᵢₘᵢₜ 157, t_{remaining} 161, and CT 145 to display 108 (FIG. 1), which can be, for example, a conventional watch-sized display having a light emitting diode (LED), for display to the user.

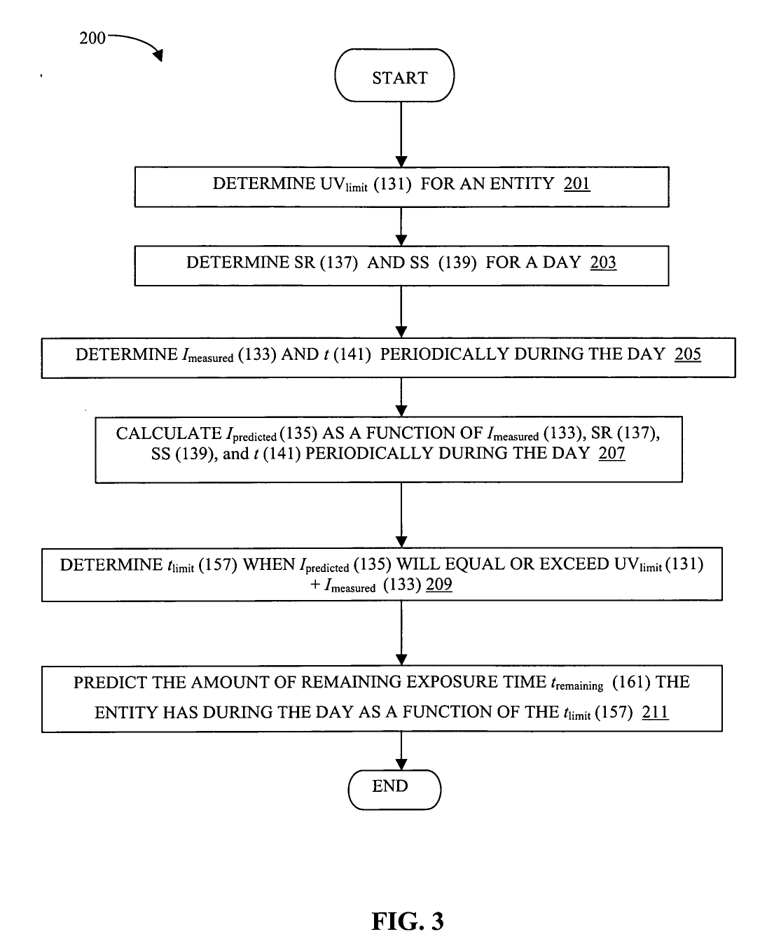

Referring now to FIG. 3, method 200 of the present invention can include, but is not limited to, the steps of determining UVₗᵢₘᵢₜ 131 for an entity (method step 201) and determining SR 137 and SS 139 for a day (method step 203). Method 200 can further include the steps of determining I_{measured} 133 and t 141 periodically during the day (method step 205), and calculating I_{predicted} 135 as a function of I_{measured} 133, SR 137, SS 139, and t 141 periodically during the day (method step 207). Method 200 can further include the steps of determine limiting time tₗᵢₘᵢₜ 157 when I_{predicted} 135 will equal or exceed UVₗᵢₘᵢₜ 131+I_{measured} 133 (method step 209), and predict the amount of remaining exposure time, t_{remaining} 161, that the entity has during the day as a function of the tₗᵢₘᵢₜ 157 (method step 211).

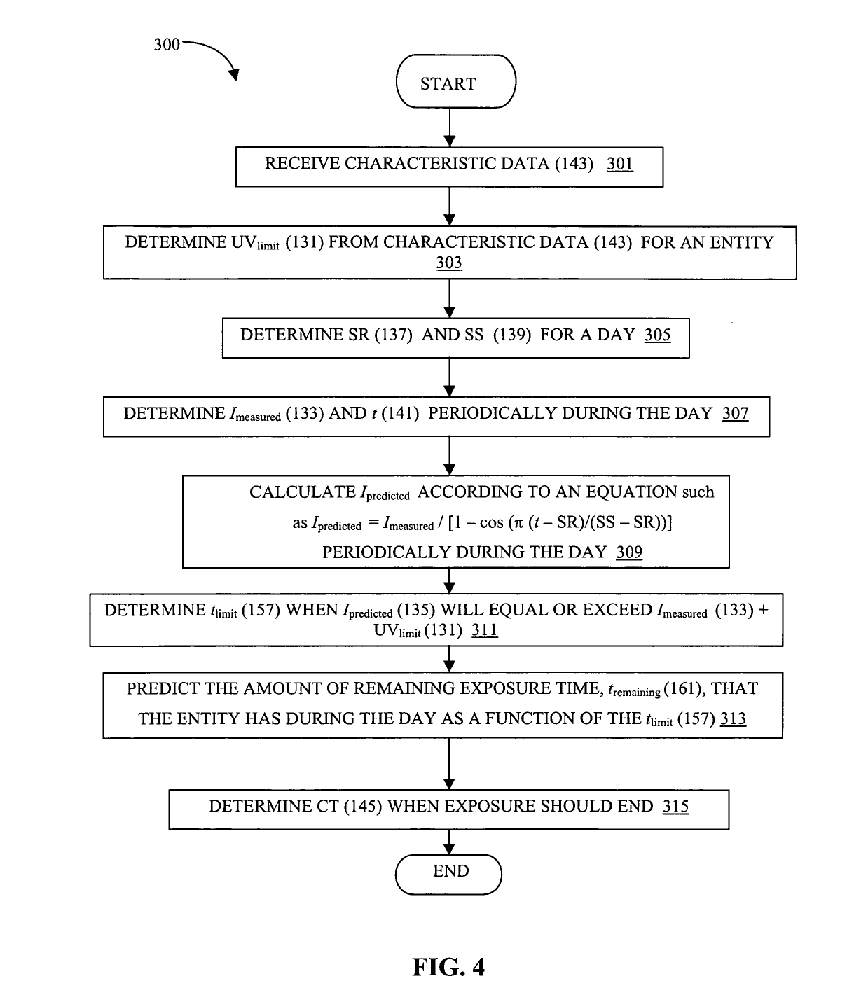

Referring now to FIG. 4, alternate method 300, an alternate embodiment of the present invention, can include, but is not limited to, the steps of receiving characteristic data 143 (method step 301), and determining UVₗᵢₘᵢₜ 131 from characteristic data 143 for an entity (method step 303). Alternate method 300 can further include the steps of determining SR 137 and SS 139 for a day (method step 305), and determining I_{measured} 133 and t 141 periodically during the day (method step 307). Alternate method 300 can still further include the steps of calculating I_{predicted} 135 (FIG. 1) according to the equation I_{predicted}=I_{measured}/[1−cos(π(t−sr)/(ss−sr))] periodically during the day (method step 309), and determining tₗᵢₘᵢₜ 157 when I_{predicted} 135 will equal or exceed I_{measured} 133+UVₗᵢₘᵢₜ 131 (method step 311). Alternate method 300 can still further include the steps of predicting the amount of remaining exposure time, t_{remaining} 161, that the entity has during the day as a function of the tₗᵢₘᵢₜ 157 (method step 313), and determining CT 145 when exposure should end (method step 315).

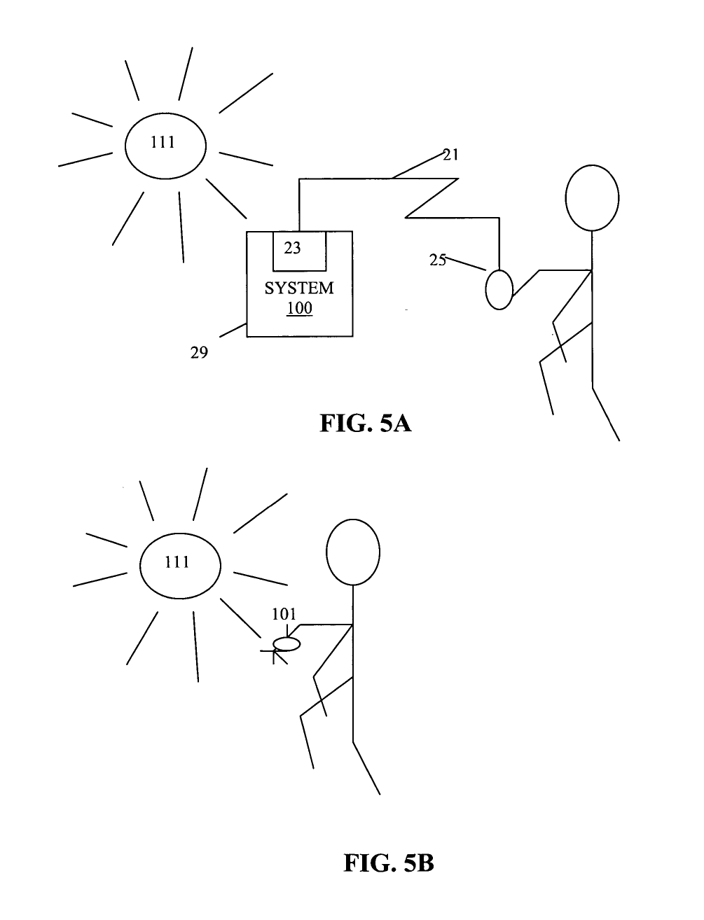

Referring now to FIG. 5A, system 100 can be incorporated in standalone device 29 which can include, but is not limited to, first transceiver 23 and system 100. A signal containing exposure information can be transmitted by first transceiver 23 to the user at second transceiver receiver/display unit 25 over electronic interface 21, which may be wired or wireless or any other type of communications technology. Second transceiver/display unit 25 can also include an input means to receive input from the user that would be transmitted back to standalone device 29 over electronic interface 21. First transceiver 23 can receive data from the user and route the data to system 100 for processing. Referring now to FIG. 5B, system 100 can be included in wearable device 101.

Although the invention has been described with respect to various embodiments, it should be realized this invention is also capable of a wide variety of further and other embodiments.

What is claimed is:

1. A system for predicting the amount of remaining exposure time an entity should be exposed to natural UV radiation during a day comprising:
means for determining a UV radiation exposure limit for the entity;
means for determining sunrise time and sunset time for the day;
means for determining irradiation and time periodically during the day;
means for calculating a predicted irradiation exposure as a function of said irradiation, said sunrise time, said sunset time, and said time periodically during the day;
means for determining a limiting time when said predicted irradiation exposure will equal or exceed said UV radiation exposure limit; and
means for predicting the amount of remaining exposure time the entity has during the day to avoid the harmful effects of UV radiation exposure as a function of said limiting time.

2. The system of claim 1 further comprising:
means for receiving characteristic data; and
means for calculating said UV exposure limit based on said characteristic data.

3. The system of claim 1 wherein said means for periodically calculating said predicted irradiation exposure comprises:
means for calculating said predicted irradiation exposure according to the equation:
I_{predicted}=I_{measured}/[1−cos(π(t−SR)/(SS−SR))];
wherein I_{predicted} represents the predicted irradiation exposure, I_{measured} represents the irradiation, SR represents the sunrise time, SS represents the sunset time, and t represents the time.

4. The system of claim 1 further comprising:
means for determining a clock time when the UV exposure should end.

5. The system of claim 1 further comprising the step of:
means for calculating said sunrise time and said sunset time based on local latitude, local longitude, current date, and standard solar angle calculations.

6. A system for predicting the amount of remaining exposure time an entity has during a day in order to avoid the harmful effects of natural UV radiation exposure comprising:
input means capable of receiving a UV exposure limit for the entity, and a sunrise time and a sunset time for the day;
a clock capable of periodically providing a time during the day;
at least one detector capable of periodically determining irradiation during the day;
a processor capable of periodically calculating a predicted irradiation exposure as a function of said irradiation, said sunrise time, said sunset time, and said time;
said processor capable of determining a limiting time when said predicted irradiation exposure will equal or exceed said UV exposure limit; and
said processor capable of periodically predicting an amount of remaining exposure time the entity has during the day to avoid the harmful effects of the natural UV radiation exposure as a function of said limiting time.

7. The system of claim 6 wherein said input means is capable of receiving characteristic data, and wherein said processor is capable of calculating said UV exposure limit based on said characteristic data.

8. The system of claim 6 wherein said processor is capable of calculating said predicted irradiation exposure according to the equation:
I_{predicted}=I_{measured}/[1−cos(π(t−SR)/(SS−SR))];
wherein I_{predicted} represents the predicted irradiation exposure, I_{measured} represents the irradiation, SR represents the sunrise time, SS represents the sunset time, and t represents the time.

9. The system of claim 6 wherein said processor is capable of calculating a clock time when the natural UV radiation exposure should end.

10. The system of claim 6 wherein said processor is capable of calculating said sunrise time and said sunset time based on local latitude, local longitude, current date, and standard solar angle calculations.

11. The system of claim 6 wherein the natural UV radiation exposure includes predetermined wavelength bands.

12. The system of claim 6 further comprising:
at least one filter for filtering predetermined wavelength bands from a radiation source, wherein said at least one detector capable of receiving said filtered predetermined wavelength bands and calculating irradiation from said filtered predetermined wavelength bands.

13. A method for predicting the amount of remaining natural UV radiation exposure time an entity has during a day comprising the steps of:
determining a UV exposure limit for the entity;
determining sunrise time and sunset time for the day;
determining irradiation and time periodically during the day;
calculating a predicted irradiation exposure as a function of the irradiation, the sunrise time, the sunset time, and the time periodically during the day;
determining limiting time when the predicted irradiation exposure will equal or exceed the UV exposure limit; and
predicting the amount of remaining natural UV radiation exposure time the entity has during the day as a function of the limiting time.

14. The method of claim 13 wherein said step of determining the UV exposure limit comprises the steps of:
receiving characteristic data; and
calculating the UV exposure limit based on the characteristic data.

15. The method of claim 13 wherein said step of periodically calculating the predicted irradiation exposure comprises the step of:
calculating the predicted irradiation exposure according to the equation:
I_{predicted}=I_{measured}/[1−cos(π(t−SR)/(SS−SR))];
wherein I_{predicted} represents the predicted irradiation exposure, I_{measured} represents the irradiation, SR represents the sunrise time, SS represents the sunset time, and t represents the time.

16. The method of claim 13 further comprising the step of:
determining a clock time when natural UV radiation exposure should end.

17. The method of claim 13 further comprising the step of:
calculating the sunrise time and the sunset time based on local latitude, local longitude, current date, and standard solar angle calculations.

18. The method of claim 13 wherein natural UV radiation exposure includes predetermined wavelength bands.

19. The method of claim 13 wherein said step of periodically determining irradiation comprises the step of:
filtering the predetermined wavelength bands; and
determining the irradiation from the filtered predetermined wavelength bands.

20. An apparatus for predicting the amount of remaining exposure time an entity should be exposed to natural UV radiation during a day comprising:
an exposure prediction device including:
means for determining a UV radiation exposure limit for the entity;
means for determining sunrise time and sunset time for the day;
means for determining irradiation and time periodically during the day;
means for calculating a predicted irradiation exposure as a function of said irradiation, said sunrise time, said sunset time, and said time periodically during the day;
means for determining a limiting time when said predicted irradiation exposure will equal or exceed said UV radiation exposure limit; and
means for predicting the amount of remaining exposure time the entity has during the day to avoid the harmful effects of natural UV radiation exposure as a function of said limiting time.

21. The apparatus of claim 20 further comprising:
a first transceiver associated with said exposure prediction device;
a second transceiver associated with the entity; and
an electronic interface between said first transceiver and said second transceiver, said electronic interface capable of providing a communications path between said exposure prediction device and the entity;
wherein said first transceiver is capable of transmitting said remaining exposure time from said exposure prediction device to the entity and receiving characteristic data;
wherein said second transceiver is capable of transmitting said characteristic data and receiving and displaying said remaining exposure time.

22. The apparatus of claim 20 wherein said exposure prediction device is wearable by the entity.
